(19) United States
(12) Patent Application Publication
(10) Pub. No.: US 2017/0346702 A1
(43) Pub. Date: Nov. 30, 2017

(54) COMPUTER IMPLEMENTED METHOD FOR DISPLAYING A USER INTERFACE

(71) Applicant: EATON INDUSTRIES (NETHERLANDS) B.V., Hengelo (NL)

(72) Inventors: Bernie Wasserman, Ontario (CA); Siddharth Ramesh Patel, Pune (IN); Madhulika Vijay Deogoji, Lanja (IN)

(21) Appl. No.: 15/538,199

(22) PCT Filed: Dec. 4, 2015
(86) PCT No.: PCT/EP2015/078691

§ 371 Date: Jun. 21, 2017

(30) Foreign Application Priority Data
Dec. 22, 2014 (IN) 3820/DEL/2014
Feb. 11, 2015 (GB) 1502287.4

(51) Int. Cl. H04L 12/24; G06F 3/0484; H04L 12/26; G05B 19/05; G06F 17/27; G06F 3/0482

(52) U.S. Cl. CPC H04L 41/22; H04L 43/04; H04L 43/14; H04L 41/20; G05B 19/05; G06F 3/0484; G05B 2219/1215; G06F 3/0482; G06F 17/2705

(57) ABSTRACT

A computer implemented method for displaying a user interface in a monitoring system for monitoring a number of slave devices in a network by a master device includes the steps of: writing software code for monitoring a number of slave devices in a network; defining at least one display template with a number of data fields in the software code; compiling the software code including the defined display template; running the compiled software code; and while running the compiled software code on the master device, performing the steps of: selecting a slave device by a user from a list of slave devices connected to the network; loading and parsing a data file for the selected slave device; activating at least one of the data fields in the at least one display template depending on the parsed data file; and reading data from the selected device.

### CROSS-REFERENCE TO PRIOR APPLICATIONS

This application is a U.S. National Phase application under 35 U.S.C. §371 of International Application No. PCT/EP2015/078691, filed on Dec. 4, 2015, and claims benefit to Indian Patent Application No. 3820/DEL/2014, filed on Dec. 22, 2014 and British Patent Application No. 1502287.4, filed on Feb. 11, 2015. The International Application was published in English on Jun. 30, 2016 as WO 2016/102175 A1 under PCT Article 21(2).

### FIELD

The invention relates to a computer implemented method for displaying a user interface in a monitoring system for monitoring a number of slave devices in a network by a master device.

### BACKGROUND

In the field of monitoring electrical slave devices in a high voltage environment, monitoring software is installed on a master device, which is connected via a network to the slave devices. These slave devices could for example be starters, soft starters and variable frequency drives, which are typically used in a high voltage environment with switchgear.

Typically, the monitoring software is build incorporating several monitoring screens for each slave device on the network. The software is then compiled and stored in the master device.

When the network configuration of slave devices is altered, the monitoring software typically has to be amended or rewritten, recompiled and stored on the master device. However, before the software can be run on the master device, the master device needs to be powered down and as a result the high voltage environment with switchgear needs to be powered down.

Furthermore, for each slave device views need to be defined separately in the software in order to display the slave device specific parameters. This results in a large code base and a big compiled software program, which needs to be stored in the master device's memory. However, typically the memory of a master device in high voltage systems is limited.

Also maintenance of a plurality of views for a number of slave devices, which could be up to 120 slave devices, is difficult and would require a highly skilled software engineer.

US 2008016466 describes a method for customizing the graphical user interface for medical appliances, which have been designed for multi purposes. The graphical user interface can be defined by a separate file, which can be modified by the user, without the need to recompile the core program and the need for a software engineer. This enables the user of the medical appliance to customize the user interface to his or her needs.

However, the user interface for the medical appliance is generated for the specific device and is not suitable for dynamically generating different views for separate slave devices in a master-slave configuration in a network environment. Furthermore, the full layout of a view is defined in the separate file, similar to a HTML file for rendering a webpage, which makes changes still complex due to the complexity of the separate file.

### SUMMARY

In an embodiment, the present invention provides a computer implemented method for displaying a user interface in a monitoring system for monitoring a number of slave devices in a network by a master device. The method comprises: writing software code for monitoring a number of slave devices in a network; defining a display template with a number of data fields in the software code; compiling the software code including the defined display template; running the compiled software code on a master device; and while running the compiled software code on the master device, performing the steps of: selecting a slave device by a user from a list of slave devices connected to the network; loading and parsing a data file for the selected slave device; activating at least one of the data fields in the display template depending on the parsed data file; reading data from the selected device; integrating the read data into the activated data fields of the display template; and displaying the display template with the integrated data.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic diagram of the first steps of an embodiment of the computer implemented method according to the invention.

FIG. 2 shows a schematic diagram of the further steps of an embodiment of the computer implemented method according to the invention.

FIG. 3 shows an embodiment of a tree structure of templates for the computer implemented method according to the invention.

### DETAILED DESCRIPTION

The invention provides a computer implemented method, which method comprises the steps of:

writing software code for monitoring a number of slave devices in a network;

defining at least one display template with a number of data fields in the software code;

compiling the software code including the defined display template; and

running the compiled software code;

while running the compiled software code on the master device performing the steps of:

selecting a slave device by a user from a list of slave devices connected to the network;

loading and parsing a data file for the selected slave device;

activating at least one of the data fields in the at least one display template depending on the parsed data file;

reading data from the selected device;

integrating the read data into the activated data fields of the display template; and

displaying the at least one display template with the integrated data.

With the method according to the invention a template is defined when writing the software. The template comprises all possible display elements or data fields for a view. So, formatting of the different data fields is already done by defining the template.

Adding or changing slave devices no longer requires any downtime or re-compiling of the software, a user only needs to define in a data file, which display elements or data fields of the template are activated and thus are shown for a specific view for a specific slave device. The data file could for example furthermore define which data field shows which data read from a selected slave device. Once the data file is loaded, manually or automatically by the system, the user interface is updated and the changes immediately reflected without downtime or software modifications.

So, with the invention a single template is used to display similar data of the different slave devices in the network. The data files corresponding to the different slave devices define which data read from the specific slave device is displayed in which data fields defined in the single template.

In an embodiment of the computer implemented method according to the invention the software code is written in an object oriented language using visualization objects for displaying the template.

By defining the template using visualization objects, the type and formatting is incorporated in the object, which is easily enabled or disabled depending on the definitions in the data file for a specific slave device.

In a further embodiment of a computer implemented method according to the invention a number of templates are defined with a number of data fields and the templates are arranged in a tree structure for displaying different details of a selected slave device.

Typically, when monitoring slave devices, one has an overview screen on which a specific slave device can be selected and then a few different views, which zoom in on different aspects of the slave device.

By defining a number of templates and arranging them in a tree structure a general navigation structure is obtained, which is then customized by the data file enabling and disabling certain data fields of one of the templates and filled with data read from the specific slave device.

Preferably, the compiled software code is run on a programmable logic controller (PLC).

Typically, the compiled software code is flashed into the memory of the programmable logic controller. This ensures that when the master device is powered on, the compiled software is readily available in the flash memory, making the master device robust, which is a typical requirement in high voltage environments.

In yet another embodiment of the computer implemented method according to the invention a separate data file is provided for each slave device connected to the network.

Preferably, the data files are stored in a database.

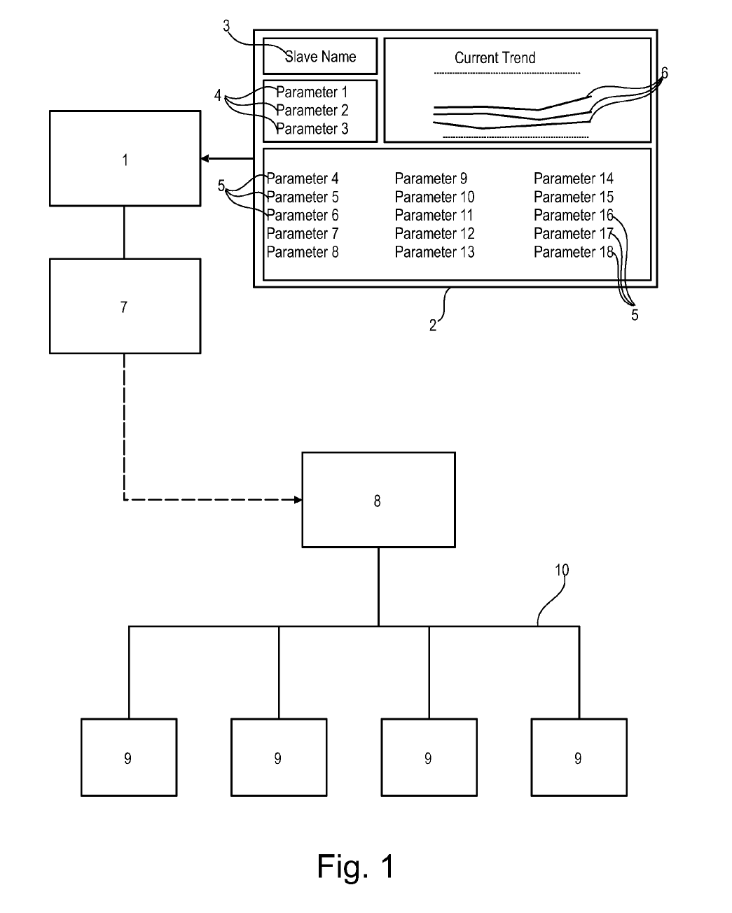

FIG. 1 shows a schematic diagram of the first steps of an embodiment of the computer implemented method according to the invention.

In the first step 1 software code is written to provide a monitoring system for monitoring a number of slave devices in a network by a master device. In this software code writing step 1 at least one template 2 is defined. The template 2 has a number of data fields 3, 4, 5, 6. These data fields 3, 4, 5, 6 define positions for data read in a later step from a selected slave device. Preferably, the data fields 3, 4, 5, 6 already are provided with formatting in the template 2.

After the software code 1, including the template 2, is finished, the software code is compiled in step 7 and then flashed into the memory of a master device 8, which is connected to a number of slave devices 9 via a network 10.

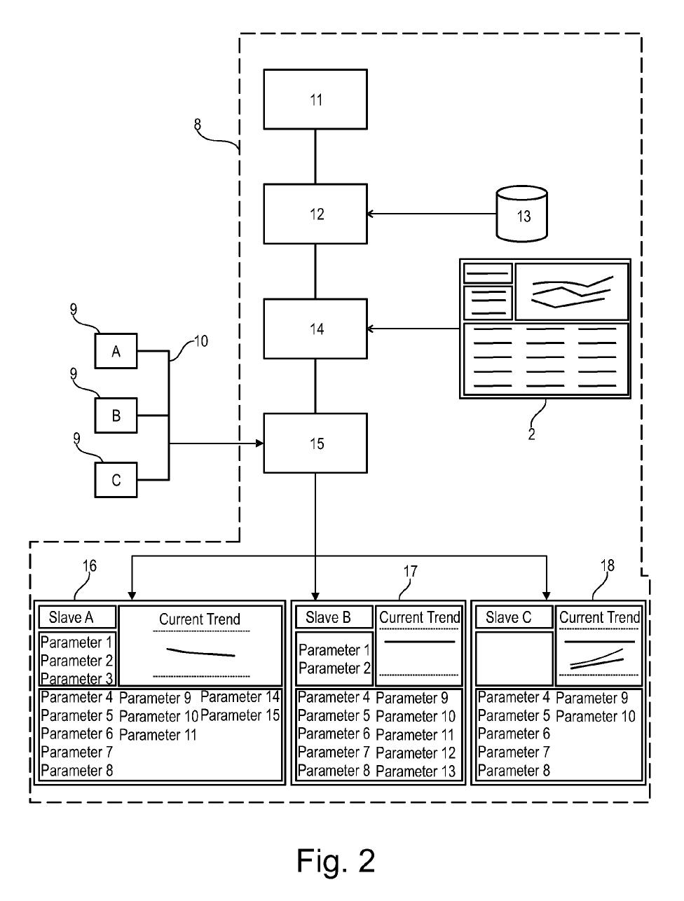

FIG. 2 shows a schematic diagram of the further steps which are performed on the master device 8 after the software code is flashed into the memory of the master device 8.

First a user selects at step 11 a slave device 9 from a list of slave devices (A, B, C). Then in the next step 12 a data file corresponding to the selected slave device 9 is loaded from a database 13.

In step 14, the data parsed from the data file is used to select which data fields 3, 4, 5, 6 are to be activated in the template 2.

Data is read in step 15 from the selected slave device 9 via the network 10 and this data is integrated in the activated data fields 3, 4, 5, 6.

The resulting view 16, 17, 18 is then displayed being customized accordingly to the capabilities of the slave devices 9, i.e. A, B, C respectively.

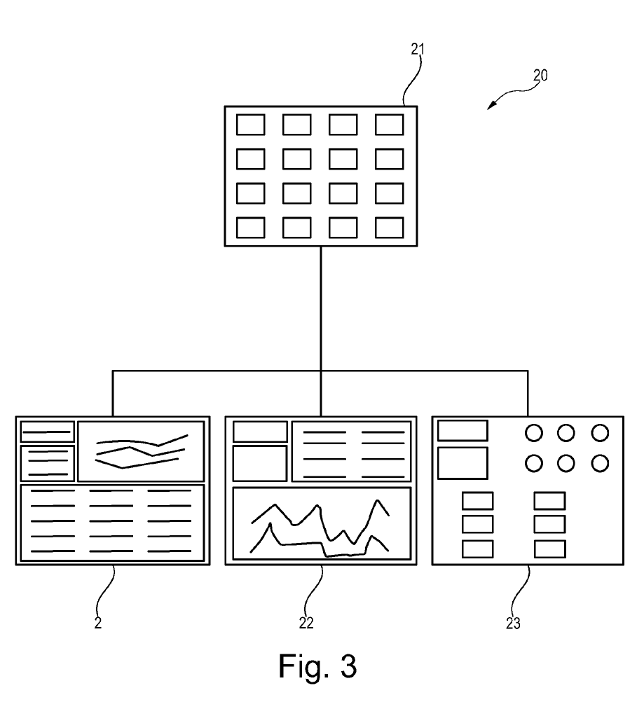

FIG. 3 shows an embodiment of a tree structure 20 of templates 2, 21, 22, 23 for the computer implemented method according to the invention.

For example the template 21 can be used to provide an overview of the available slave devices 9 on the network 10 in which for example identifiers of the slave devices 9 are shown. The view resulting from this template 21 can be used to select a specific slave device 9.

Then after selecting a slave device 9, one of the templates 2, 22, 23 can be used to generate a view for displaying specific data of the selected slave device 9.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer implemented method for displaying a user interface in a monitoring system for monitoring a number of slave devices in a network by a master device, the method comprising:
writing software code for monitoring a number of slave devices in a network;
defining display template with a number of data fields in the software code;
compiling the software code including the defined display template;
running the compiled software code on a master device; and
while running the compiled software code on the master device, performing the steps of:
selecting a slave device by a user from a list of slave devices connected to the network;
loading and parsing a data file for the selected slave device;
activating at least one of the data fields in the display template depending on the parsed data file;
reading data from the selected device;
integrating the read data into the activated data fields of the display template; and
displaying the display template with the integrated data.

2. The computer implemented method according to claim 1, wherein the software code is written in an object oriented language using visualization objects for displaying the display template.

3. The computer implemented method according to claim 1, wherein a number of display templates are defined with a number of data fields and wherein the display templates are arranged in a tree structure for displaying different details of a selected slave device.

4. The computer implemented method according to claim 1, wherein the compiled software code is run on a programmable logic controller (PLC).

5. The computer implemented method according to claim 4, wherein the compiled software code is flashed into the memory of the programmable logic controller.

6. The computer implemented method according to claim 1, wherein a separate data file is provided for each slave device connected to the network.

7. The computer implemented method according to claim 6, wherein the data files are stored in a database.
